(19) United States
(12) Patent Application Publication
(10) Pub. No.: US 2024/0193589 A1
(43) Pub. Date: Jun. 13, 2024

(54) Server

(71) Applicant: TOYOTA JIDOSHA KABUSHIKI KAISHA, Toyota-shi Aichi-ken (JP)

(72) Inventors: Tatsuya OWASHI, Nagoya-shi Aichi-ken (JP); Kuniaki Murakami, Nagoya-shi Aichi-ken (JP); Koji Hetsugi, Toyota-shi Aichi-ken (JP); Tomokazu Ishii, Okazaki-shi Aichi-ken (JP); Naoki Ishihara, Nisshin-shi Aichi-ken (JP)

(73) Assignee: TOYOTA JIDOSHA KABUSHIKI KAISHA, Toyota-shi Aichi-ken (JP)

(21) Appl. No.: 18/532,323

(22) Filed: Dec. 7, 2023

(30) Foreign Application Priority Data
Dec. 8, 2022 (JP) 2022-196190

(51) Int. Cl. G06Q 20/36

(52) U.S. Cl. CPC G06Q 20/3678

(57) ABSTRACT

A server communicates with a holder terminal that is a terminal device of a holder of an NFT. The NFT is associated with a vehicle. The vehicle is stored by a dealer. The server includes a communication device and a processing device. The communication device obtains a monitoring record of a state of the vehicle, generated by a monitoring device that monitors the state of the vehicle during storage of the vehicle. The processing device generates transaction data including the monitoring record, triggered by reception of a generation request to generate the transaction data. The processing device generates the transaction data, triggered by reception of the generation request from the holder terminal.

### CROSS REFERENCE TO RELATED APPLICATIONS

This nonprovisional application is based on Japanese Patent Application No. 2022-196190 filed on Dec. 8, 2022 with the Japan Patent Office, the entire contents of which are hereby incorporated by reference.

### BACKGROUND

### Field

The present disclosure relates to a server.

### Description of the Background Art

Japanese Patent Application Laid-Open No. 2020-027592 discloses a system for managing rights information on assets on a block chain. The system includes first and second computer systems. The first computer system manages rights information using block chain technology. The second computer system converts rights information into tokens. The holder of the token may have an asset corresponding to the token.

### SUMMARY

As an example of a token issued using distributed ledger technology such as a block chain technology, an NFT (Non-Fungible Token) is drawing attention. Forgery or tampering of NFT is extremely difficult. The NFT may be associated with an object and used as a certificate for certifying the authority to possess or utilize the object.

The object may not be stored by the owner, but may be stored by an administrator different from the owner. This administrator is expected to properly store (e.g., maintain) objects and appropriately create storage records of objects. When such a storage record is registered in the distributed ledger, the user who can refer to the distributed ledger can confirm the storage record. However, the administrator may unduly create (e.g., forgery) the storage record and register the storage record in the distributed ledger.

The present disclosure has been made to solve the above-mentioned problems, and an object of the present disclosure is to avoid a situation in which an inappropriate storage record of an object is registered in a distributed ledger when the object is stored by an administrator different from its owner.

A server of the present disclosure is configured to communicate with a holder terminal, the holder terminal being a terminal device of a holder of a non-fungible token issued with distributed ledger technology. The non-fungible token is associated with an object. The object is stored by an administrator administrating the object. The server includes a communication device and a processing device. The communication device is configured to obtain a monitoring record of a state of the object, the monitoring record being generated by a monitoring device that monitors the state of the object during storage of the object. The processing device generates transaction data including the monitoring record, triggered by reception of a generation request to generate the transaction data. The processing device generates the transaction data, triggered by reception of the generation request from the holder terminal.

According to the above configuration, the transaction data is generated at a timing preferred by the holder, and is therefore generated at a timing that is not predicted by the administrator. Thus, the administrator is induced to properly store (maintain, for example) the object so that the monitoring record is determined to be appropriate, regardless of the timing at which the generation request is received. As a result, it is possible to make the administrator store the object appropriately. In addition, according to the above configuration, the monitoring record is generated objectively by the monitoring device and thereafter registered as a storage record in a distributed ledger. As a result, it is possible to avoid a situation where the administrator generates an improper storage record and such a storage record is registered in the distributed ledger.

The processing device may further be configured to generate the transaction data, triggered by reception of the generation request from an administrator terminal that is a terminal device of the administrator.

According to the above configuration, the transaction data is generated, triggered by each of reception of the generation request from the holder terminal and reception of the generation request from the administrator terminal. Thus, the frequency at which the transaction data is generated can be increased. As a result, the granularity of the monitoring record can be increased. Further, convenience for the administrator can be enhanced.

The processing device may further be configured to generate the transaction data again, triggered by elapse of a predetermined time from last generation of the transaction data.

According to the above configuration, the transaction data is generated, triggered by each of reception of the generation request from the holder terminal and elapse of a predetermined time. Thus, the frequency at which the transaction data is generated can be increased. As a result, the granularity of the monitoring record can be increased. Further, the monitoring record may be generated without using the holder terminal, and therefore, convenience for the holder can be enhanced.

Triggered by reception of the generation request, the communication device may obtain the monitoring request, and the processing device may generate the transaction data including the obtained monitoring record.

According to the above configuration, both the obtainment of the monitoring record and the generation of the transaction data are performed, triggered by reception of the generation request. Thus, the transaction data can be generated immediately.

The server may further include a storage device in which the monitoring record obtained by the communication device is stored. Triggered by reception of the generation request, the processing device may generate the transaction data including the monitoring record stored in the storage device.

According to the above configuration, the monitoring record is stored in the storage device, and thereafter the transaction data including this monitoring record is generated, triggered by reception of the generation request. Thus, even when it is difficult to immediately obtain the monitoring record from the monitoring device upon receiving the generation request (for example, when communication between the monitoring device and the communication device is broken off), the transaction data can be generated immediately based on the monitoring record stored in the storage device.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 schematically shows a configuration of an information processing system according to an embodiment.

FIG. 2 is a diagram illustrating a configuration of a monitoring system according to the embodiment.

FIG. 3 is a flowchart illustrating processing executed by a server according to the embodiment.

FIG. 4 is a flowchart illustrating processing executed by the server according to the first modification.

FIG. 5 is a flowchart illustrating processing executed by a server according to a second modification.

FIG. 6 is a flowchart illustrating processing executed by a server according to a third modification.

### DESCRIPTION OF THE EMBODIMENTS

Hereinafter, embodiments of the present disclosure will be described in detail with reference to the accompanying drawings. The same or corresponding parts in the drawings are denoted by the same reference numerals, and description thereof will not be repeated. In an embodiment, by way of example, the object is a vehicle.

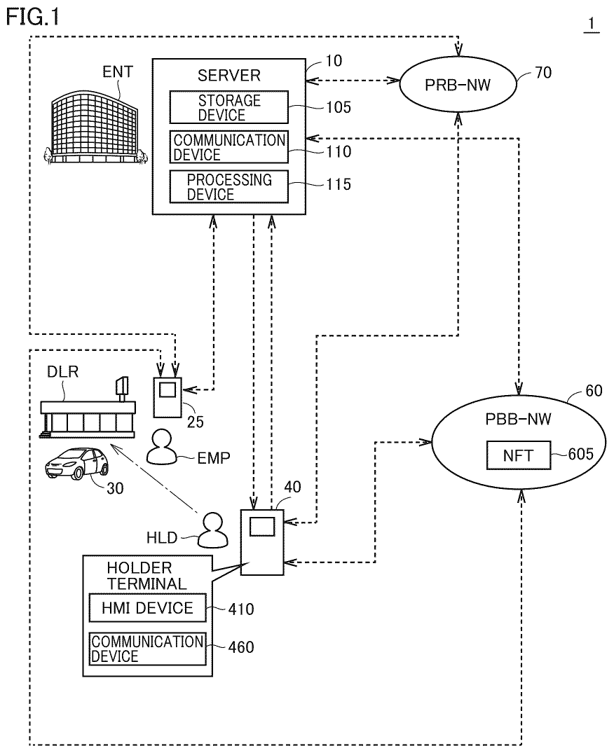

FIG. 1 schematically shows a configuration of an information processing system according to an embodiment. Referring to FIG. 1, information processing system 1 includes a server 10, an administrator terminal 25, a vehicle 30, and a holder terminal 40. The information processing system 1 further includes a public block chain network 60 (specifically, a plurality of nodes not shown) and a private block chain network 70 (specifically, a plurality of nodes not shown).

Hereinafter, the public block chain network 60 and the private block chain network 70 are denoted as PBB-NW 60 and PRB-NW 70, respectively.

The server 10 is operated by an operator ENT. The server 10 includes a storage device 105, a communication device 110, and a processing device 115.

The storage device 105 stores programs and data to be executed by the processing device 115. The storage device 105 further holds a distributed ledger for recording a history of transactions in the PBB-NW 60 and a distributed ledger for recording a history of transactions in the PRB-NW 70. Thus, the server 10 can function as a node of the PBB-NW 60 and a node of the PRB-NW 70.

The communication device 110 communicates with an external device of the server 10, such as the administrator terminal 25, the holder terminal 40, each node of the PBB-NW 60, or each node of the PRB-NW 70.

The processing device 115 includes a CPU (Central Processing Unit) and a memory (both are not shown). The memory includes a ROM (Read Only Memory) and a RAM (Random Access Memory).

The processing device 115 executes various kinds of processing in accordance with a program and data stored in the storage device 105. The processing device 115 generates transaction data (TX data) including, for example, monitoring records (described below) of the vehicle 30. The processing device 115 transmits the TX data to the PRB-NW 70 through the communication device 110. Transmitting the TX data to the PRB-NW 70 corresponds to broadcasting the TX data to each node of the PRB-NW 70. After broadcast, the TX data is propagated, captured and approved to other nodes of the PRB-NW 70.

The administrator terminal 25 is an example of a terminal device of the dealer DLR, and is carried by the employee EMP of the dealer DLR. The dealer DLR manages and stores the vehicle 30 in its garage (not shown). The employee EMP is expected to properly store (e.g., maintain) the vehicle 30 and properly create a storage record of the vehicle 30.

The holder terminal 40 includes an HMI device 410 and a communication device 460. The HMI device 410 receives an input of a user operation by the holder HLD. The holder HLD is the holder of the NFT 605 (described later). The user operation includes an operation (registration instruction operation) for instructing registration of the storage record of the vehicle 30 in the PRB-NW 70.

The communication device 460 communicates with external devices of the holder terminal 40, such as the server 10, nodes of the PBB-NW 60, and nodes of the PRB-NW 70.

The PBB-NW 60 is a distributed ledger network accessible by each of the server 10, the administrator terminal 25 and the holder terminal 40. Each of the server 10, the administrator terminal 25 and the holder terminal 40 can confirm with reference to the distributed ledger stored in the node of the PBB-NW 60.

The NFT 605 is issued on the PBB-NW 60 using distributed ledger technology. The NFT 605 is associated with the vehicle 30, and is used as a certificate for certifying the authority to possess or use the vehicle 30. The holder HLD is an owner or user of the vehicle 30, having the authority to own or utilize the vehicle 30 based on the NFT 605. The “usage of the vehicle 30” may be that the owner of the vehicle 30 uses the vehicle 30, or that a person different from the owner of the vehicle 30 uses the vehicle 30 temporarily (for example, rental).

Similar to the PBB-NW 60, the PRB-NW 70 is a distributed ledger network accessible by each of the server 10, the administrator terminal 25 and the holder terminal 40. Each of the server 10, the administrator terminal 25 and the holder terminal 40 can confirm with reference to the distributed ledger stored in the node of the PRB-NW 70. The PRB-NW 70 is operated by the operator ENT.

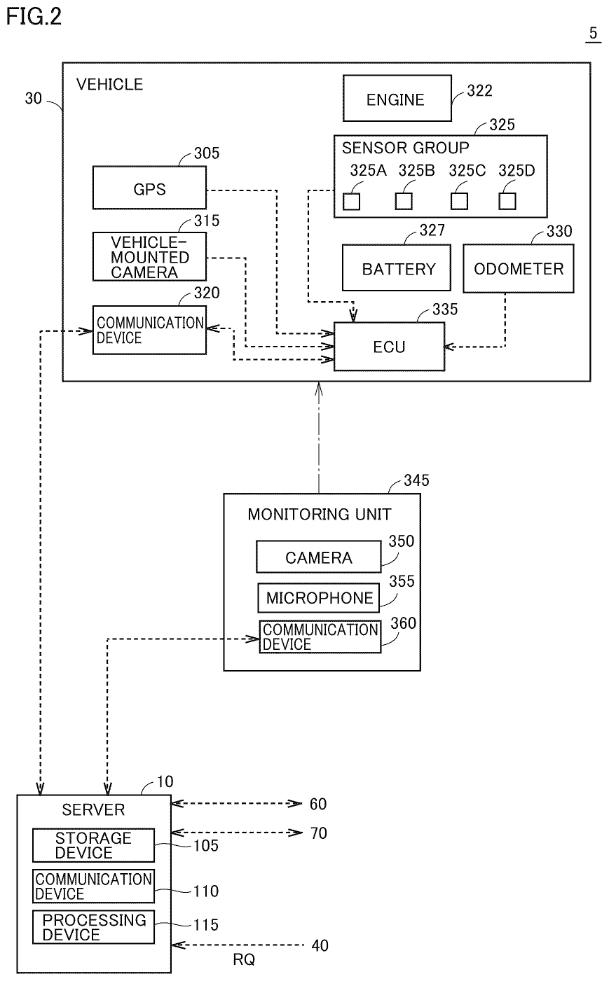

FIG. 2 is a diagram illustrating a configuration of a monitoring system according to the embodiment. Referring to FIG. 2, the monitoring system 5 includes a vehicle 30, a monitoring unit 345, and a server 10.

The vehicle 30 includes a GPS receiver 305, a vehicle-mounted camera 315, a communication device 320, an engine 322, a sensor group 325, a battery 327, an odometer 330, and an ECU (Electronic Control Unit) 335.

The GPS receiver 305 monitors the current position of the vehicle 30 by obtaining the position information of the vehicle 30. The monitoring result (location information) of the GPS receiver 305 may be used to ensure that the vehicle 30 is stored in the garage of the dealer DLR.

The vehicle-mounted camera 315 captures an image around the vehicle 30. An image captured by the vehicle-mounted camera 315 is also referred to as a “first image”. The first image is used to ensure that the vehicle 30 is not impacted by an external object while the vehicle 30 is out of the garage of the dealer DLR and is running. The first image may be either a still image or a moving image. The communication device 320 is configured to communicate with the server 10.

The sensor group 325 includes a voltage sensor 325A, an air pressure sensor 325B, an oil level sensor 325C, and a viscosity sensor 325D. The voltage sensor 325A, the air pressure sensor 325B, the oil level sensor 325C, and the viscosity sensor 325D monitor (measure) the voltage of the battery 327, the air pressure of the tire of the vehicle 30, the remaining amount of oil for the engine 322, and the viscosity of the oil, respectively. In this way, the sensor group 325 monitors the state of the vehicle 30 (in this example, the object to be measured) and creates a monitoring record of the state of the vehicle 30. The sensor group 325 is an example of a “monitoring device” of the present disclosure.

The battery 327 stores electric power for traveling the vehicle 30. The odometer 330 monitors (measures) the travel distance of the vehicle 30 based on the rotation speed of the tire of the vehicle 30. The monitoring result (measured value) of the odometer 330 may be used to ensure that the vehicle 30 is not running.

The ECU 335 obtains, as vehicle information, information including positional information, the first image, a result of monitoring by the sensor group 325, and a measurement value of the odometer 330. The ECU 335 controls various devices of the vehicle 30, such as the communication device 320 and the engine 322. The ECU 335 transmits vehicle information to the server 10 through the communication device 320.

The monitoring unit 345 is installed outside the vehicle 30 in the garage of the dealer DLR. The monitoring unit 345 includes a camera 350, a microphone 355, and a communication device 360.

The camera 350 monitors (images) the state of the vehicle 30 (around) during storage of the vehicle 30. The image captured by the camera 350 is also referred to as a “second image”. The second image may be used to ensure that the vehicle 30 is not impacted by an external object (or is not damaged by an intruder into the garage) during storage of the vehicle 30. The second image may be used as a photographing result of the maintenance operation. In this case, the second image may be used to ensure that maintenance of the vehicle 30 by the employee EMP has been performed. The second image may be either a still image or a moving image.

The microphone 355 monitors (detects) sound around the vehicle 30, and creates a record of the sound. The sound is used to ensure that the vehicle 30 is not collided with an external object during storage of the vehicle 30 (a large sound such as a shock sound is not detected).

The communication device 360 is configured to transmit results of monitoring of each of the camera 350 and the microphone 355 to the server 10.

The dealer DLR (more specifically, the employee EMP) is expected to properly store (e.g., maintain) the vehicle 30 and properly create a storage record of the vehicle 30. When such a storage record is registered in the distributed ledger of the PBB-NW 60 or the PRB-NW 70, the user who can refer to the distributed ledger can confirm the storage record. However, the dealer DLR may unduly create (e.g., manually forgery) the storage record and register the storage record in the distributed ledger.

The server 10 according to the embodiment is provided with a configuration for addressing the above problems. Specifically, the communication device 110 obtains a monitoring record (in this example, a measurement of each sensor) generated by the sensor group 325 during storage of the vehicle 30 from the sensor group 325 through the communication device 320. The processing device 115 is configured to generate the TX data, triggered by the reception of a generation request RQ for generating the TX data including the monitoring record. The generation request RQ is transmitted from the holder terminal 40 to the server 10 in response to the registration instruction operation described above. The processing device 115 generates TX data, triggered by the reception of the generation request RQ from the holder terminal 40, and then transmits the TX data to the PRB-NW 70 through the communication device 110.

With such a configuration, the TX data is generated at a timing preferred by the holder HLD. Thus, the TX data is generated at a timing not predicted by the employee EMP, and then transmitted to the PRB-NW 70 and registered in the distributed ledger. As a result, the employee EMP is prompted to properly store (e.g., maintain) the vehicle 30 so that the monitoring record is determined to be appropriate regardless of the timing at which the generation request is received. Accordingly, the vehicle 30 can be appropriately stored in the dealer DLR. In addition, according to the above configuration, the monitoring record is registered in the distributed ledger as an objective storage record based on the measurement results of the sensor group 325, unlike storage records manually created by the employee EMP. As a result, it is possible to avoid a situation in which the storage record inappropriately created by the employee EMP is registered in the distributed ledger of the PRB-NW 70. Further, since the monitoring record is registered in the distributed ledger, it is difficult to tamper with.

The communication device 110 obtains the monitoring record from the sensor group 325, triggered by the reception of the generation request RQ. The processing device 115 generates the TX data such that the TX data includes the monitoring record thus obtained. That is, the server 10 executes both the obtainment of the monitoring record and the generation of the TX data, triggered by the reception of the generation request RQ.

With this configuration, the TX data can be generated immediately in response to the generation request RQ and transmitted to the PRB-NW 70. As a result, the TX data (monitoring record) can be registered in the distributed ledger as soon as possible.

The server 10 may execute processing for registering a part of the monitoring record registered in the distributed ledger of the PRB-NW 70 in the distributed ledger of the PBB-NW 60. Specifically, the server 10 may calculate the hash value of the monitoring record registered in the distributed ledger of the PRB-NW 70 at predetermined time intervals, generate TX data for registering the hash value in the distributed ledger of the PBB-NW 60 as a snapshot, and transmit the TX data to the PBB-NW 60. The information indicating the predetermined time is appropriately determined by the operator ENT and stored in the storage device 105.

According to such processing, the minimum necessary data among the monitoring records registered in the distributed ledger of the PRB-NW 70 is registered in the distributed ledger of the PBB-NW 60 as a snapshot. Thus, any user of the terminal device accessible to the PBB-NW 60 can confirm a part of the monitoring record.

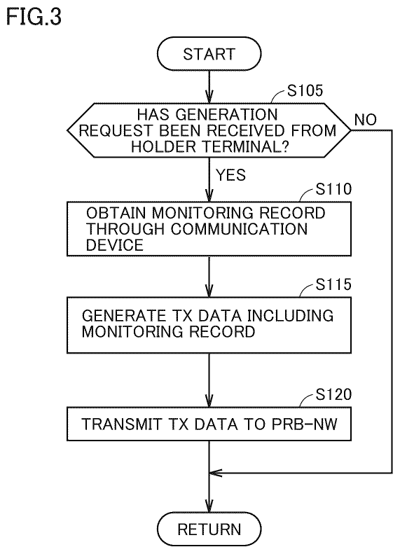

FIG. 3 is a flowchart illustrating processing executed by the server 10 according to the embodiment. This flowchart is executed at predetermined time intervals. The time interval is stored in the storage device 105, for example. Hereinafter, the step is abbreviated as “S”.

Referring to FIG. 3, server 10 determines whether or not it has received a generation request RQ from holder terminal 40 (S105). When the server 10 has not received the generation request RQ (NO in S105), the process proceeds to return. When the server 10 has received the generation request RQ (YES in S105), the process proceeds to S110.

The server 10 obtains the monitoring record from the sensor group 325 through the communication devices 320 and 110 (S110). The server 10 generates the TX data so that the TX data includes the monitoring record thus obtained (S115), and transmits the TX data to the PRB-NW 70 (S120).

As described above, according to the embodiment, when the vehicle 30 is stored by an administrator (in this example, dealer DLR) different from the owner of the vehicle 30, it is possible to avoid a situation in which an inappropriate storage record of the vehicle 30 is registered in the distributed ledger.

In addition, any user of the terminal device that can refer to the distributed ledger can recognize an appropriate maintenance timing of the vehicle 30 by checking the monitoring record registered in the distributed ledger.

### Modified Example 1

In the first modification, the server 10 (communication device 110) obtains the monitoring record from the sensor group 325 at predetermined time intervals. The server 10 stores the obtained monitoring record in the storage device 105. Upon receipt of the generation request RQ, the server 10 generates and transmits TX data to the PRB-NW 70 such that the TX data includes a monitoring record stored in the storage device 105.

With such a configuration, after the monitoring record is once stored in the storage device 105, TX data including the monitoring record in the storage device 105 is generated and transmitted to the PRB-NW 70, triggered by reception of the generation request RQ. Thus, the monitoring record stored in the storage device 105 until the generation request RQ is received is collectively registered in the distributed ledger of the PRB-NW 70, triggered by the reception of the generation request RQ. As a result, the efficiency of the data processing can be improved, and the monitoring record when the generation request RQ is not received can also be registered in the distributed ledger.

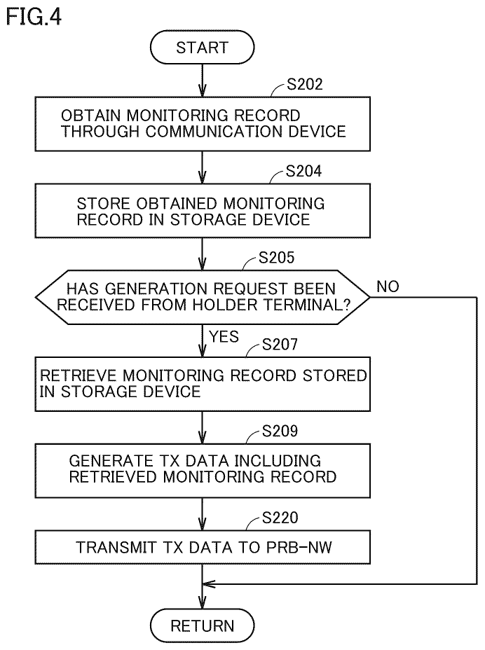

FIG. 4 is a flowchart illustrating processing executed by the server 10 according to the first modification. This flowchart is executed at predetermined time intervals.

Referring to FIG. 4, server 10 obtains monitoring records from sensor group 325 through communication devices 320 and 110 (S202). The server 10 stores the obtained monitoring record in the storage device 105 (S204).

The server 10 determines whether or not it has received the generation request RQ from the holder terminal 40 (S205). When the server 10 has not received the generation request RQ (NO in S205), the process proceeds to return. Thus, the monitoring record is stored in the storage device 105 until the generation request RQ is received (until YES in S205) (S202 and S204 are repeated).

When receiving the generation request RQ (YES in S205), the server 10 retrieves the monitoring record stored (stored) in the storage device 105 (S207). Then, the server 10 generates TX data including the retrieved monitoring record (S209), and transmits the TX data to the PRB-NW 60 (S220).

The monitoring record of the sensor group 325 may be stored in a storage device (not shown) external to the server 10 until the server 10 receives the generation request RQ. In this case, the server 10 accesses the external storage device, triggered by the reception of the generation request RQ, generates TX data including the monitoring record stored in the external storage device, and transmits the TX data to the PRB-NW 60. This makes it possible to register the monitoring record in the PRB-NW 70 while preventing an increase in the amount of data in the storage device 105.

According to the first modification, even when it is difficult to immediately obtain the monitoring record from the sensor group 325 when the generation request RQ is received (for example, when communication is interrupted between the communication devices 110 and 320), the TX data can be immediately generated and transmitted based on the monitoring record stored in the storage device 105 or the external storage device.

### Modified Example 2

The server 10 may be further configured to generate TX data, triggered by reception of a generation request RQ from the administrator terminal 25. In this case, the generation request RQ is transmitted from the administrator terminal 25 to the server 10 in response to a registration instruction operation by the employee EMP using the administrator terminal 25. This registration instruction operation is performed, for example, when the employee EMP completes maintenance of the vehicle 30.

With such a configuration, the TX data is generated with the reception of the generation request RQ from the holder terminal 40 and the reception of the generation request RQ from the administrator terminal 25 as triggers. This can increase the frequency with which the TX data is generated.

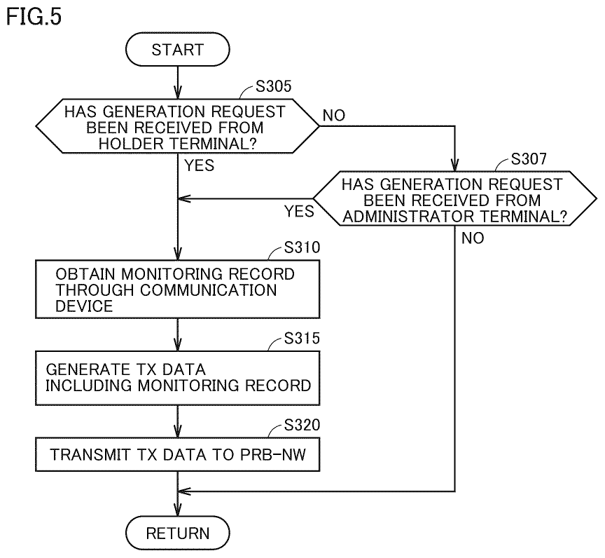

FIG. 5 is a flowchart illustrating processing executed by the server 10 according to the second modification. This flowchart is executed at predetermined time intervals.

Referring to FIG. 5, this flowchart differs from the flowchart of the above-described embodiment (FIG. 3) in that S307 is added. Steps S305 and S310 to S320 are the same as steps S105 and S110 to S120, respectively.

When the server 10 has not receive the generation request RQ from the holder terminal 40 (NO in S305), the server 10 determines whether or not it has received the generation request RQ from the administrator terminal 25 (S307). When the server 10 has not received the generation request RQ from the administrator terminal 25 (NO in S307), the process proceeds to return. When the server 10 has received the generation request RQ from the administrator terminal 25 (YES in S307), the process proceeds to S310.

According to the second modification, the granularity of the monitoring record can be increased. In addition, since the TX data can be generated at a timing preferred by the dealer DLR, the convenience of the dealer DLR can be enhanced.

### Modified Example 3

The server 10 may be further configured to generate the TX data again, triggered by elapse of a predetermined time from the last generation of the TX data. The information indicating the predetermined time is appropriately determined by the operator ENT and stored in the storage device 105.

With such a configuration, the TX data is generated by using the reception of the generation request RQ from the holder terminal 40 and the passage of the predetermined time as triggers. This makes it possible to increase the frequency with which the TX data is generated, similarly to the third modification.

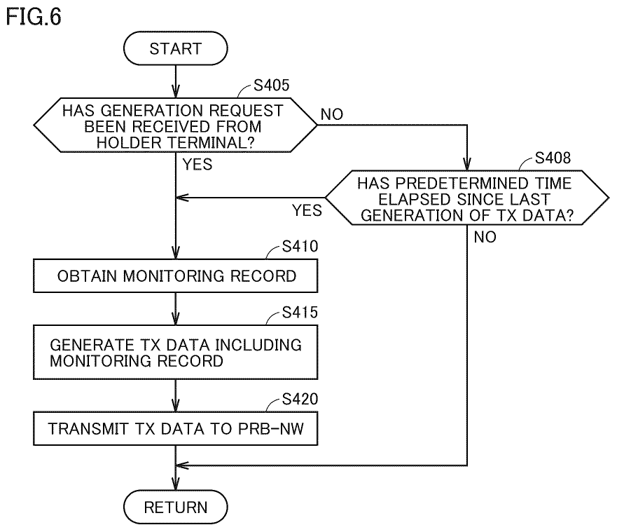

FIG. 6 is a flowchart illustrating processing executed by the server 10 according to the third modification. This flowchart is executed at predetermined time intervals.

Referring to FIG. 6, this flowchart differs from the flowchart of the above-described embodiment (FIG. 3) in that S408 is added. Steps S405 and S410 to S420 are the same as steps S105 and S110 to S120, respectively.

When the server 10 does not receive the generation request RQ from the holder terminal 40 (NO in S405), the server 10 determines whether or not a predetermined time has elapsed since the last generation of the TX data (S408). The last generation of the TX data corresponds to the time when S415 was performed last time. When the predetermined time has not elapsed (NO in S408), the process proceeds to return. When the predetermined time has elapsed (YES in S408), the process proceeds to S410.

According to the third modification, the granularity of the monitoring record can be increased. Further, since the monitoring record can be created without using the holder terminal 40 (YES in S408), the holder HLD does not necessarily require the registration instruction operation. As a result, the convenience of the holder HLD can be enhanced.

### Modified Example 4

The server 10 may execute the usage record registration process for registering the usage record of the vehicle 30 in the distributed ledger of the PRB-NW 70 during the usage period of the vehicle 30. The usage period is a period during which the vehicle 30 is used and moves out of the garage. In this example, the usage record is the travel record of the vehicle 30 during the usage period. This travel record is created to ensure that the vehicle 30 is not impacted by an external object during the use period. The traveling record includes, for example, positional information of the vehicle 30 and the first image. The use record registration processing corresponds to transmission of TX data including the use record to the PRB-NW 70, and is sequentially executed during the use period. For example, the server 10 sequentially obtains the position information of the vehicle 30, and determines whether or not the vehicle 30 is separated from the garage (storage place) based on the position information of the vehicle 30. The server 10 starts the use record registration process, triggered by the result of the determination that the vehicle 30 is separated from the garage.

When the usage record is registered, any user of the device accessible to the PRB-NW 70 can confirm the status of the vehicle 30 during the usage period by referring to the distributed ledger of the PRB-NW 70.

The server 10 may execute processing for registering a part of the usage record registered in the distributed ledger of the PRB-NW 70 in the distributed ledger of the PBB-NW 60. Specifically, the server 10 may calculate the hash value of the usage record registered in the distributed ledger of the PRB-NW 70 at every predetermined time, generate TX data for registering the hash value in the distributed ledger of the PBB-NW 60 as a snapshot, and transmit the TX data to the PBB-NW 60. The information indicating the predetermined time is appropriately determined by the operator ENT and stored in the storage device 105.

According to such processing, the minimum necessary data of the usage records registered in the distributed ledger of the PRB-NW 70 is registered in the distributed ledger of the PBB-NW 60 as a snapshot. Thus, any user of the terminal device accessible to the PBB-NW 60 can confirm a part of the usage record.

### OTHER MODIFIED EXAMPLES

The “monitoring device” of the present disclosure is not limited to the sensor group 325, but may be a camera 350. In this case, the server 10 obtains the second image created by the camera 350 from the monitoring unit 345 as a monitoring record.

The “monitoring device” may be a microphone 355. In this case, the server 10 obtains the audio record created by the microphone 355 from the monitoring unit 345 as a monitoring record.

The “monitoring device” may be a GPS receiver 305. In this case, the position information of the vehicle 30 is used as a monitoring record. The “monitoring device” may be an odometer 330. In this case, the measurement value of the odometer 330 is used as a monitoring record.

In order to ensure that the vehicle 30 is not running (not utilized) and is stored in the garage of the dealer DLR, each of the GPS receiver 305 and the odometer 330 may be used as a “monitoring device” in some embodiments. For example, when the vehicle 30 is moved by a rocker vehicle, the position information changes, while the measurement of the odometer 330 does not change. In such a case, it may be ensured that the vehicle 30 is not available (e.g., rental) based on measurements of the odometer 330. Further, when the tire is turned idle during maintenance of the vehicle 30, the measurement value of the odometer 330 changes, but the positional information does not change. In such a case, since the vehicle 30 itself is not moving, it is possible to ensure that the vehicle 30 is stored in the garage based on the position information.

The object is not limited to the vehicle 30, but may be other types of tangible objects, such as pictures, bones, jewelry, noble metals, or moving objects including ships or aircraft.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A server that communicates with a holder terminal, the holder terminal being a terminal device of a holder of a non-fungible token issued with distributed ledger technology,
the non-fungible token being associated with an object,
the object being stored by an administrator administrating the object,
the server comprising:
a communication device that obtains a monitoring record of a state of the object, the monitoring record being generated by a monitoring device that monitors the state of the object during storage of the object; and
a processing device that generates transaction data including the monitoring record, triggered by reception of a generation request to generate the transaction data, wherein
the processing device generates the transaction data, triggered by reception of the generation request from the holder terminal.

2. The server according to claim 1, wherein the processing device further generates the transaction data, triggered by reception of the generation request from an administrator terminal that is a terminal device of the administrator.

3. The server according to claim 1, wherein the processing device further generates the transaction data again, triggered by elapse of a predetermined time from last generation of the transaction data.

4. The server according to claim 1, wherein
triggered by reception of the generation request,
the communication device obtains the monitoring request, and
the processing device generates the transaction data including the obtained monitoring record.

5. The server according to claim 1, further comprising a storage device in which the monitoring record obtained by the communication device is stored, wherein
triggered by reception of the generation request, the processing device generates the transaction data including the monitoring record stored in the storage device.
